(19) United States
(12) Patent Application Publication
(10) Pub. No.: US 2026/0197514 A1
(43) Pub. Date: Jul. 9, 2026

(54) PRESENTATION, TIMING AND SCHEDULE MANAGEMENT FOR BROADCAST PROGRAMMING IN BETTING APPLICATIONS

(71) Applicant: SINCLAIR BROADCAST GROUP, LLC, Hunt Valley, MD (US)

(72) Inventors: Kevin James COTLOVE, Reisterstown, MD (US); Sangsu KIM, Owings Mills, MD (US)

(73) Assignee: SINCLAIR BROADCAST GROUP, LLC, Hunt Valley, MD (US)

(21) Appl. No.: 19/271,962

(22) Filed: Jul. 17, 2025

Related U.S. Application Data
(63) Continuation-in-part of application No. 19/200,015, filed on May 6, 2025.
(60) Provisional application No. 63/743,142, filed on Jan. 8, 2025.

(51) Int. Cl. H04N 21/262; H04N 21/2187; H04N 21/478

(52) U.S. Cl. CPC H04N 21/2625; H04N 21/2187; H04N 21/478

(57) ABSTRACT

Disclosed herein are system, method, and computer program product aspects for implementing a live sporting events broadcasting system for a betting application. An aspect operates by tuning to a channel corresponding to a live event and receiving advanced television systems committee (ATSC) signaling via the channel. The aspect further operates by retrieving page configuration information and time information from the ATSC signaling and determining that a current time matches the time information. Finally, the aspect operates by launching a betting application using the page confirmation information and performing one or more betting operations using the betting application in association with the live event.

### CROSS-REFERENCE TO RELATED APPLICATIONS

This application is a continuation-in-part of U.S. Non-provisional Application No. Ser. No. 19/200,015, filed on May 6, 2025, entitled “Presentation, Timing and Schedule Management for Broadcast Programming in Betting Applications,” which claims benefit to U.S. Provisional Application No. 63/743,142, filed on Jan. 8, 2025, entitled “Presentation, Timing and Schedule Management for Broadcast Programming in Betting Applications,” both of which are incorporated herein in their entireties.

### BACKGROUND

Providing streaming services of live sporting events through the Internet is a complex task, especially in a new application on a user device, such as a mobile phone or tablet. The cost of getting a license for the live sporting events can be millions to billions of dollars given that the streaming rights are controlled by major leagues. In addition, some streaming rights are assigned exclusively to certain entities, thus making it nearly impossible to stream these events. On the other hand, it is possible to show live events via terrestrial broadcast systems, such as the Advanced Television Systems Committee (ATSC) 3.0 system. However, the current system may need to be improved to facilitate dynamic and accurate live sporting events broadcasting.

### BRIEF DESCRIPTION OF THE FIGURES

The accompanying drawings, which are incorporated herein and form part of the specification, illustrate the present disclosure and, together with the description, further serve to explain the principles of the disclosure and enable a person of skill in the relevant art(s) to make and use the disclosure.

FIG. 1 illustrates an example live broadcast system, according to some aspects of the disclosure.

FIG. 2 illustrates another example live broadcast system, according to some aspects of the disclosure.

FIG. 3 illustrates a block diagram of example devices in the live broadcast system, according to some aspects of the disclosure.

FIG. 4 illustrates an example betting program enabled live broadcast system, according to some aspects of the disclosure.

FIG. 5 illustrates an example method of broadcast service, according to some aspects of the disclosure.

FIG. 6 illustrates an example method of playing a live event, according to some aspects of the disclosure.

FIG. 7 illustrates an example method of launching a betting application, according to some aspects of the disclosure.

FIG. 8 illustrates an example method of calculating and using delay, according to some aspects of the disclosure.

FIG. 9 illustrates an example computer system for implementing some aspects of the disclosure or portion(s) thereof.

The present disclosure is described with reference to the accompanying drawings. In the drawings, generally, like reference numbers indicate identical or functionally similar elements. Additionally, generally, the left-most digit(s) of a reference number identifies the drawing in which the reference number first appears.

### DETAILED DESCRIPTION

Some aspects of this disclosure include apparatus, system, computer program product, and method aspects for a live sporting events broadcasting system for a betting application.

In some aspects, a betting application allows users to place wagers on various events, such as live sporting events. Conventionally, the users need to constantly juggle between the betting application and a display of the sporting events on a TV or a computer screen. This creates inconvenience because betting applications are highly sensitive to timeliness. For example, the betting application may include a betting program that asks the users to bet within 5 minutes on which team would score next. Thus, the users may need to check the TV or the computer screen for the game progress and team performance while paying attention to the betting application as the betting program approaches its closing time. This kind of watching-both-devices requirement would degrade user experience and potentially discourage the users from participating in the betting program. Thus, it would be desired to provide a live display of the sporting events in the betting application so that the users can watch the sporting events and participate in the betting program on the same screen. This makes the users feel comfortable and thus they are more likely to participate in the betting program.

In some aspects, it may be difficult to integrate the betting application with the Internet-based sports streaming services, such as ESPN®, because of the cost and the process of getting licenses to stream, as discussed above. Thus, it may be more practical to use terrestrial broadcast systems, such as the ATSC 3.0 system, to display the sporting events. However, steps may need to be taken to provide a seamless user experience using the terrestrial broadcast systems. For example, the terrestrial broadcast systems are limited to a geolocation since the range of a broadcasting station is limited. Thus, the betting application needs to know sporting events that are available in the area where the user device is located. For another example, the betting application needs to know the real-time delay of the broadcasted sporting events. This is critical because the betting application closes the betting prior to the betting condition actually occurring. If a betting program asks which team scores in the second half of a game, no one should be allowed to place a bet after the beginning of the second half of the game (or a period before the second half of the game) because otherwise one of the team may have already scored. With a delay in signal transmission and process, the betting application may miscalculate the time point to close the betting. A broadcasting system designed for the betting application that provides timing and scheduling management is needed.

In some aspects, the broadcasting system may include a scheduling server that provides scheduling information to the betting application. The scheduling information may indicate sporting events that are broadcast in a local area and start/stop times of these sporting events. Based on the scheduling information, the betting application can choose to display one or more sporting events.

In some aspects, a time of capture information may be embedded in broadcast signals so that the betting application can decode the broadcast signals and determine when certain frames of a video were captured. The betting application can then calculate a real-time delay by comparing the time of capture with a current time. With the real-time delay, the betting application can close the betting at an appropriate time point.

In some aspects, information provided to the betting application, including the scheduling information and the time of capture information, may be encrypted so that only the intended recipients are able to obtain and use the information. The betting application can request access to the information from an authorization server. The authorization server may approve and send an approval message back to the betting application. The approval message may include decryption keys needed to decrypt the information.

In some aspects, the betting application can use metadata defined in the ATSC 3.0 3.0 standard to synchronize with broadcast content, such as the live sporting events. For example, the ATSC 3.0 signaling may include A/331 signaling defined in the ATSC 3.0 standard. The A/331 signaling may further include page configuration information, such as hypertext markup language (HTML) entry pages location description (HELD). In some aspects, the page configuration information may include or indicate uniform resource locators (URLs) that lead to interactive HTML5 pages containing the betting application. For example, interactive HTML5 applications may be distributed through broadcast signals, such as the A/331 signaling, in service layer signaling. Interactive content, including HTML entry pages and other resources, is packaged and sent via the ATSC 3.0 signals.

Furthermore, the A/331 signaling may include time information, such as distribution window description (DWD), which includes or indicates timing windows of the live sports events being broadcasted. This enables the betting application to accurately open and close betting windows aligned with event occurrences. The combination of the page configuration information and the time information ensures that receivers launch the betting applications when the live sporting events are scheduled and terminate access when the live sporting events end.

In some aspects, the time of capture information can be embedded into broadcast signals, such as the ATSC 3.0 signaling. For example, an ATSC 3.0 headend, such as a packager or a broadcaster, may insert the time of capture information into the ATSC 3.0 signaling. In some aspects, the ATSC 3.0 headend can insert the time of capture information into a Society of Cable Telecommunications Engineers (SCTE)-35 marker that is transmitted along with video signals in the ATSC 3.0 signaling. In some aspects, the SCTE-35 marker may include digital cue messages defined by the SCTE in the standard SCTE 35. The SCTE-35 marker can be in-band splice point in a digital video stream in the ATSC 3.0 signaling and can be used for advertisement insertion, program start/stop markers, and other purposes. In some embodiments, the ATSC 3.0 headend can insert the time of capture information periodically into the ATSC 3.0 signaling, such as every 10 seconds. The ATSC 3.0 headend can also insert the time of capture information into the ATSC 3.0 signaling when certain events occur, such as a start of a game, a goal, mid time, end of the game, or others. The receivers can retrieve the time of capture information from the ATSC 3.0 signaling and calculate the real-time delay as discussed above.

Finally, since the betting applications are contained in the interactive HTML5 pages, the betting applications can integrate user interaction features that enable users to provide feedback. The betting applications can also update odds for betting operations and provide personalized alerts that are synchronized with broadcast content. In addition, when errors or signal interruptions occur, the betting applications can report them to the ATSC 3.0 headend to have them resolved.

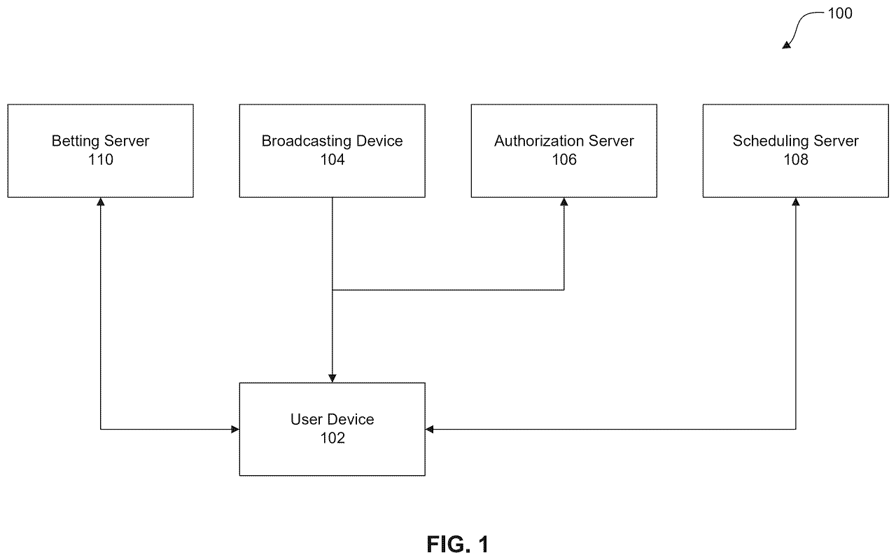

FIG. 1 illustrates an example live broadcast system 100, according to some aspects of the disclosure. The live broadcast system 100 is provided for the purpose of illustration only and does not limit the disclosed aspects. The live broadcast system 100 may include, but is not limited to, a user device 102, a broadcasting device 104, an authorization server 106, a scheduling server 108, and a betting server 110. In some aspects, the user device 102, the authorization server 106, the scheduling server 108, and the betting server 110 may include, but is not limited to, computer systems, servers, cloud systems, cloud servers, laptops, desktops, personal computers, databases, user equipment, and the like.

In some aspects, the broadcasting device 104 may include a broadcasting station, such as a TV transmitter or an ATSC 3.0 transmitter. The broadcasting device 104 may transmit signals of live sporting events in a local area. Thus, devices in the local area, such as the user device 102, can receive the signals. However, the user device 102 may not know the signals and corresponding live sporting events that are being transmitted by the broadcasting device 104. In some aspects, the user device 102 may query some information from the scheduling server 108. For example, the user device 102 may transmit a program information request to the scheduling server 108. The program information request may indicate a geolocation of the user device 102. In some aspects, the user device 102 may include a global positioning system (GPS) or a global navigation satellite system (GNSS) chipset that receives signals from satellites to determine its geolocation. The scheduling server 108 may identify live sporting events that are available in the geolocation. For example, the scheduling server 108 may identify a list of broadcasting devices, such as the broadcasting device 104, and their respective ranges. Thus, the scheduling server 108 may determine one or more broadcasting devices that cover the user device 102. Next, the scheduling server 108 may determine a list of live sporting events that are being broadcasted or will be broadcasted by the one or more broadcasting devices. For example, the scheduling server 108 may store or have access to a lookup table that lists live sporting events broadcasted by each broadcasting device. Finally, the scheduling server 108 may inform the user device 102 of the list of live sporting events. For example, the scheduling server 108 may transmit scheduling information to the user device 102. In some aspects, the scheduling information may include the list of live sporting events. In addition, the scheduling information may also include other information about each live sporting event, such as an expected start time, an expected stop time, and channel information. In some aspects, the channel information may include an ATSC 3.0 frequency or an ATSC 3.0 tuner identification (ID). In such a case, the user device 102 receives a live sporting event broadcast based on the channel information of the live sporting event, such as by tuning a receiver of the user device 102 to the ATSC 3.0 frequency.

In some aspects, the user device 102 may need to determine a real-time delay between a live sporting event and the broadcast signals. For example, a baseball player may have hit a home run at 7:00 PM, but the broadcast signals may deliver video signals of the home run hit at 7:05 PM. Thus there is a 5-minutes delay between the live sporting event and the broadcast signals. This can be due to the time for processing the video as well as the time for transmitting the broadcast signals. In some aspects, a time of capture may be embedded into the broadcast signals. For example, one or more frames in the video may correspond to the home run. Thus, the broadcasting signals may bundle the one or more frames with time stamps that correspond to the time of capturing the home run. Thus, when receiving the broadcasting signals, the user device 102 can determine when the home run happened based on the time stamps. Furthermore, the user device 102 may also determine a current time. Therefore, the user device 102 can calculate the real-time delay by subtracting the time stamps from the current time.

In some aspects, the channel information and/or the time stamps may be encrypted so that only authorized devices can obtain and use them. In some aspects, the user device 102 can be authorized by the authorization server 106. For example, the user device 102 may transmit a request to the authorization server 106. The request may indicate one or more live sporting events that the user device 102 would like to access. In response, the authorization server 106 may transmit an approval message back to the user device 102. In some aspects, the approval message may include one or more decryption keys to decrypt the channel information and/or the timestamps. Decryption keys used to decrypt the channel information and the timestamps can be the same or different.

In some aspects, a betting company running the betting application may establish a betting server 110. The betting server 110 may act similarly as the authorization server 106 and the scheduling server 108 to provide information to the user device 102. For example, the betting server 110 may provide the scheduling information to the user device 102. In addition, the betting server 100 may also provide decryption keys to decrypt the channel information and/or the time stamps.

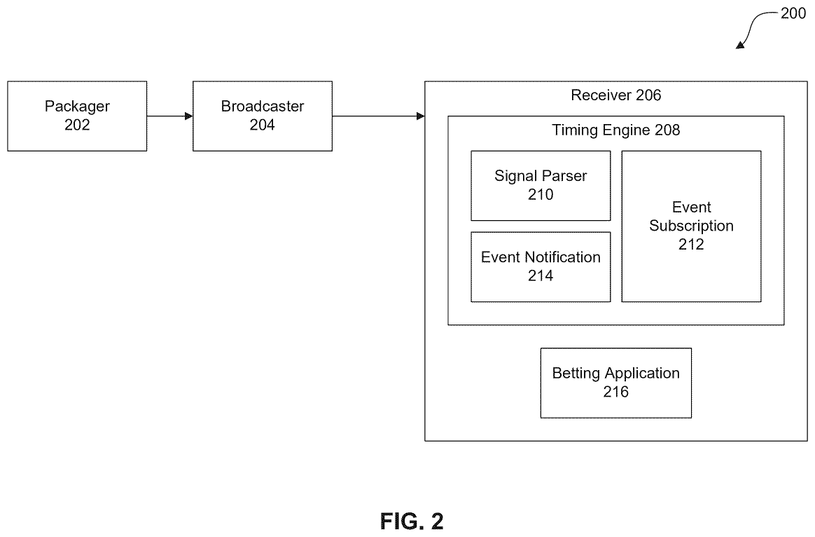

FIG. 2 illustrates another example a live broadcast system 200, according to some aspects of the disclosure. The live broadcast system 200 is provided for the purpose of illustration only and does not limit the disclosed aspects. The live broadcast system 200 may include, but is not limited to, a packager 202, a broadcaster 204, and a receiver 206. In some aspects, the receiver 206 further includes a timing engine 208, which includes a signal parser 210, an event subscription 212, and an event notification 214, and a betting application 216. The betting application 216 can be located within the receiver 206 as shown here in FIG. 2. For example, a user device can include both the receiver 206 and the betting application 216. In some aspects, the betting application 216 can be located outside of the receiver 206. For example, a second user device, connected to the user device, may launch the betting application 216. The packager 202, the broadcast 204, and the receiver 206 may include, but is not limited to, computer systems, servers, cloud systems, cloud servers, laptops, desktops, personal computers, databases, user equipment, and the like.

In some aspects, the packager 202 can be an ATSC 3.0 packager (or other packagers configured according to other ATSC standards). The packager 202 can prepare media content and generate ATSC 3.0 signaling (or signaling configured according to other ATSC standards) that includes video, audio, caption, and metadata. The ATSC 3.0 signaling can correspond to IP-compatible delivery formats used in ATSC 3.0. For example, the packager 202 can prepare the media content in the format of ROUTE/DASH or MMT. In some aspects, the packager 202 can also insert page configuration information, such as HELD, and time information, such as DWD, into the ATSC 3.0 signaling. As discussed above, the page configuration information can include or indicate URLs that lead to interactive HTML5 pages containing the betting application 216. The time information may include or indicate timing windows of the live sports events being broadcasted.

In some aspects, the packager 202 may insert backup information into the ATSC 3.0 signaling. For example, the packager 202 may insert backup page configuration information into the ATSC 3.0 signaling. When the page configuration information is corrupted or the receiver 206 otherwise fails to retrieve the page configuration information, the receiver 206 can retrieve the backup page configuration information containing same information as the page configuration information. Similarly, the packager 202 may insert backup time information into the ATSC 3.0 signaling.

In some aspects, the page configuration information and the time information are location specific. As discussed above, the receiver 206 can receive the ATSC 3.0 signaling that matches a location of the receiver 206, such as the local area. Thus, the packager 202 may insert the page configuration information and the time information corresponds to the location of the receiver 206.

Furthermore, the packager 202 can insert metadata, such as the SCTE-35 marker, into the ATSC 3.0 signaling. As discussed above, the metadata may include time of capture information that can be used by the receiver 206 to calculate a real-time delay so that the receiver 206 can make a time adjustment based on the real-time delay for betting operations.

In some aspects, the broadcaster 204 can be an over the air (OTA) broadcasting unit. The broadcaster 204 may take the ATSC 3.0 signaling (or signaling configured according to other ATSC standards) generated by the packager 202 and transmit it over radio frequency (RF) channels using an ATSC 3.0 physical layer. The broadcaster 204 may control what content is to be aired, on which RF channels, and at what time.

In some aspects, the receiver 206 can tune to RF channels that the broadcaster 204 broadcasts the ATSC 3.0 signaling, decode, and render the ATSC 3.0 signaling. The receiver 206 can include, but not limited to, a set-top box, an integrated smart TV, a network-connected gateway platform, a PC tuner, a mobile device, and so on. In some aspects, the receiver 206 can tune to a channel corresponding to a live event, as discussed above. The receiver 206 can then receive ATSC 3.0 signaling via the channel.

In some aspects, the receiver 206 can include the timing engine 208. The timing engine 208 can further include the signal parser 210 that can parse RF signals, such as the ATSC 3.0 signaling. For example, the signal parser 210 can decode and retrieve the page configuration information and the time information from the ATSC 3.0 signaling. The receiver 206 can then determine whether a current time matches the time information. For example, a football match is scheduled to be played from 8:00 PM to 10:30 PM. In such a case, the time information may indicate a start time of 7:55 PM, which is 5 minutes before the football game starts, and an end time of 10:35 PM, which is 5 minutes after the football game ends. In some aspects, the receiver 206 may determine that the current time is 7:56 PM. Thus, the current time matches the time information because the current time is within a time window between the start time and the end time. In such a case, the receiver 206 can launch the betting application 216 based on the page configuration information. Furthermore, when the current time passes 10:35 PM, the receiver 206 can close the betting application 216. Alternatively, the receiver 206 can instruct the betting application 216 to close one or more betting operations in the betting application 216, but keep the betting application 216 live so that users can view results but cannot make any more bets. In other aspects, the receiver 206 may determine that the current time is before the start time. For example, the receiver 206 may determine that the current time is 6:00 PM. In such a case, the receiver 206 can wait until 7:55 PM to launch the betting application 216.

In some aspects, the packager 202 may insert the time of capture information into the ATSC 3.0 signaling. For example, the packager 202 may include or be associated with a master clock, such as a global positioning system (GPS) or network time protocol (NTP) synchronization system. Thus, when video is produced, such as captured in a live event, the packager 202 can determine the time of capture based on the master clock and insert the time of capture information into the ATSC 3.0 signaling. As discussed above, the packager 202 can insert the time of capture information into SCTE-35 markers, also known as splice_info sections, embedded in the produced video. The packager 202 can then insert the SCTE-35 markers into the ATSC 3.0 signaling using moving picture experts group (MPEG) media transport (MMT) signals or DASH/ROUTEsignals as a part of metadata. In some aspects, the packager 202 can periodically update the time of capture information and insert the updated time of capture information into the ATSC 3.0 signaling. Finally, the broadcaster 204 transmits the ATSC 3.0 signaling that includes the SCTE-35 markers to the receiver 206.

In some aspects, the receiver 206 can provide the time of capture information to the betting application 216. For example, the betting application 216 can transmit a subscription request to the receiver 206. The subscription request may include a schemeIdUri and optionally a value. In some aspects, the schemeIdUri identifies an event type, such as “urn:bet:timeofcapture:2025” or a universally unique identifier (UUID) assignment to the SCTE-35 signals. The value can include conditions that filter events, such as “goal,” “halftime,” or “kickoff.” The event subscription 212 may receive and record the subscription request. Furthermore, the event subscription 212 may determine that a broadcast stream included in the ATSC 3.0 signaling matches the subscription request. For example, the live event included in the broadcast stream of the ATSC 3.0 signaling may match the schemeIdUri or the UUID. Specifically, the live event may be the type of event indicated by the schemeIdUri. Alternatively, the live event may correspond to an ID that matches the UUID. Furthermore and optionally, the event subscription 212 may determine that the event corresponds to SCTE-35 marker matches the value. For example, the SCTE-35 marker may include the time of capture information of a goal event. Thus, the time of capture information includes a time when a goal happened. If the value also indicates “goal,” the event subscription 212 determines that the SCTE-35 marker matches the value.

In some aspects, when the event subscription 212 determines that the ATSC 3.0 signaling or the broadcast content in the ATSC 3.0 signaling matches the subscription request, the event subscription 212 triggers the event notification 214 to transmit an event notification to the betting application 216. The event notification may include the SCTE-35 marker that includes the time of capture information. Furthermore, the event notification may include an event time, a receiving time, an event identification (ID), and content encoding information.

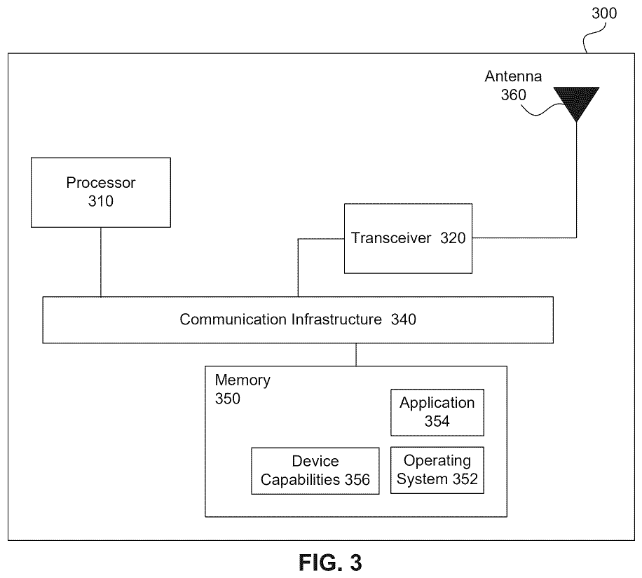

FIG. 3 illustrates a block diagram of an example electronic device 300 in the live broadcast system, according to some aspects of the disclosure. The electronic device 300 may be any of the electronic devices (e.g., the user device 102, the authorization server 106, the scheduling server 108, the betting server 110, or a combination thereof of FIG. 1 and the packager 202, the broadcaster 204, and the receiver 206, or a combination thereof of FIG. 2) of the live broadcast systems 100 or 200. The electronic device 300 includes a processor 310, one or more transceivers 320, a communication infrastructure 340, a memory 350, an operating system 352, an application 354, device capabilities 356, and antenna 360. Illustrated systems are provided as exemplary parts of electronic device 300, and electronic device 300 may include other circuit(s) and subsystem(s). Also, although the systems of electronic device 300 are illustrated as separate components, the aspects of this disclosure may include any combination of these, e.g., less, or more components.

The memory 350 may include random access memory (RAM) and/or cache, and may include control logic (e.g., computer software) and/or data. The memory 350 may include other storage devices or memory. According to some examples, the operating system 352 may be stored in the memory 350. The operating system 352 may manage transfer of data from the memory 350 and/or the one or more applications 354 to the processor 310 and/or the one or more transceivers 320. In some examples, the operating system 352 maintains one or more network protocol stacks (e.g., Internet protocol stack, cellular protocol stack, and the like) that may include a number of logical layers. At corresponding layers of the protocol stack, the operating system 352 includes control mechanisms and data structures to perform the functions associated with that layer.

According to some examples, the application 354 may be stored in the memory 350. The application 354 may include applications (e.g., user applications) used by the electronic device 300 and/or a user of the electronic device 300. In some aspects, the device capabilities 356 may be stored in the memory 350.

The electronic device 300 may also include the communication infrastructure 340. The communication infrastructure 340 provides communication between, for example, the processor 310, the one or more transceivers 320, and the memory 350. In some implementations, the communication infrastructure 340 may be a bus.

The processor 310, alone, or together with instructions stored in the memory 350 performs operations enabling electronic device 300 of the system 100 to implement the live sporting events broadcasting system, as described herein. Alternatively, or additionally, the processor 310 can be “hard coded” to implement the live sporting events broadcasting system, as described herein.

The one or more transceivers 320 transmit and receive communications signals support mechanisms for implementing the live sporting events broadcasting system. Additionally, the one or more transceivers 320 transmit and receive communications signals that support mechanisms for measuring communication link(s), generating and transmitting system information and data, and receiving the system information and data. According to some aspects, the one or more transceivers 320 may be coupled to the antenna 360 to wirelessly transmit and receive the communication signals. The antenna 360 may include one or more antennas that may be the same or different types and can form one or more antenna ports. In some aspects, the antenna 360 can be replaced or used in combination with wired communication interferences, such as Ethernet, Universal Serial Bus (USB), serial port, serial advanced technology attachment (SATA), and fiber optic interferences. The one or more transceivers 320 allow electronic device 300 to communicate with other devices that may be wired and/or wireless. In some examples, the one or more transceivers 320 may include processors, controllers, radios, sockets, plugs, buffers, and like circuits/devices used for connecting to and communication on networks. According to some examples, the one or more transceivers 320 include one or more circuits to connect to and communicate on wired and/or wireless networks.

According to some aspects of this disclosure, the one or more transceivers 320 may include a TV subsystem, an ATSC subsystem, a cellular subsystem, a WLAN subsystem, and/or a Bluetooth™ subsystem, each including its own radio transceiver and protocol(s) as will be understood by those skilled in the arts based on the discussion provided herein. In some implementations, the one or more transceivers 320 may include more or fewer systems for communicating with other devices.

In some examples, the one or more the transceivers 320 may include one or more circuits (including a WLAN transceiver) to enable connection(s) and communication over WLAN networks such as, but not limited to, networks based on standards described in IEEE 802.11.

Additionally, or alternatively, the one or more the transceivers 320 may include one or more circuits (including a Bluetooth™ transceiver) to enable connection(s) and communication based on, for example, Bluetooth™ protocol, the Bluetooth™ Low Energy protocol, or the Bluetooth™ Low Energy Long Range protocol. For example, the transceiver 320 may include a Bluetooth™ transceiver. Additionally, the one or more the transceivers 320 may include one or more circuits (including a cellular transceiver) for connecting to and communicating on cellular networks.

Furthermore, the one or more transceiver 320 may include one or more circuits to enable connection(s) and communication based on terrestrial broadcast protocols including analog TV protocols, digital TV protocols, ATSC 3.0 protocols, and so on. In some aspects, the one or more transceivers 320 may include modules that process video signals received. For example, the modules may include an ATSC tuner, a demodulator, a decoder, and other modules that correspond to the terrestrial broadcast protocols.

As discussed in more detail below with respect to FIGS. 3-9, processor 310 may implement different mechanisms for implementing the live sporting events broadcasting system as discussed with respect to the live broadcast systems 100 of FIGS. 1 and 200 of FIG. 2.

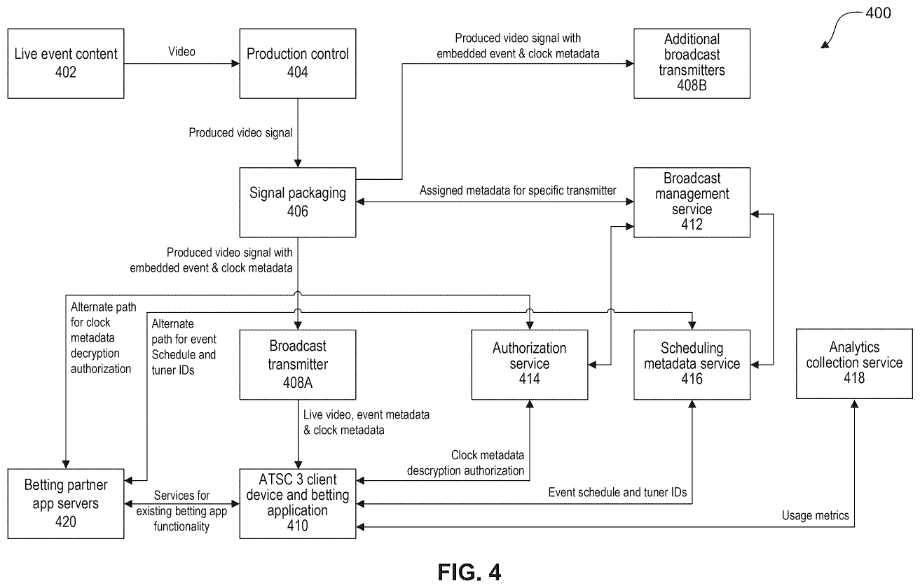

FIG. 4 illustrates an example betting program enabled live broadcast system 400, according to some aspects of the disclosure. The system 400 is provided for the purpose of illustration only and does not limit the disclosed aspects. The system 400 may include, but is not limited to, a live event content 402, a production control 404, a signal packing 406, broadcast transmitters 408A and 408B, a client device 410, a broadcast management server 412, an authorization server 414, a scheduling metadata server 416, an analytics collection server 418, and betting partner application servers 420. In some aspects, the client device 410, the broadcast management server 412, the authorization server 414, the scheduling metadata server, the analytics collection server 418, and the betting partner application servers 420 may include, but is not limited to, computer systems, servers, cloud systems, cloud servers, laptops, desktops, personal computers, databases, user equipment, and the like.

In some aspects, the live event content 402 may be a live event itself, such as a soccer game. The production control 404 may include facilities that capture the live event and produce visual and audio content of the live event. For example, the production control 404 may include a broadcasting truck or onsite production devices. In some aspects, the production control 404 may combine the visual and audio content into a video signal and transmit the video signal to the signal packaging 406. In some aspects, the signal packaging 406 may be onsite of the live event content and thus in proximity of the production control 404. In such a case, the production control 404 may transmit the video signal to the signal packaging 406 via a wired connection. In other aspects, the signal packaging 406 may be remotely located or on the cloud. In such a case, the production control 404 may transmit the video signal to the signal packaging 406 via the Internet.

In some aspects, the signal packaging 406 may insert event time information into the video signal. For example, the signal packaging 406 may insert an actual start time or a start indicator that indicates the video signal contains the live event. For example, the start indicator may be a binary number that indicates the live event with “1” and no live event with “0.” Similarly, the signal packaging 406 may insert an actual stop time or a stop indicator that indicates the video signal no longer contains the live event. In some aspects, the actual start time/the start indicator and the actual stop time/the stop indicator may be inserted into the video signal as metadata. Thus, the metadata is embedded in the video signal. In some aspects, the production control 404 may determine and insert the actual start time/the start indicator and the actual stop time/the stop indicator into the video signal before transmitting it to the signal packaging 406. In such a case, the video signal received by the signal packaging 406 already includes the embedded metadata.

In some aspects, the signal packing 406 may transmit the video signal with the embedded metadata to the broadcast transmitters 408A and 408B. It is worth noting that the signal packing 406 may transmit to additional broadcast transmitters not shown here. In some aspects, the broadcast transmitters 408A and 408B may be similar to the broadcasting device 104 in FIG. 1. In some aspects, the signal packaging 406 may selectively transmit to one or more broadcast transmitters, such as the broadcast transmitters 408A and 408B. For example, the signal packaging 406 may determine that the transmitters 408A and 408B are within a predetermined distance of the live event or that the live event is popular in locations of the transmitters 408A and 408B.

In some aspects, the broadcast management server 412, which can also be referred to as a broadcast management service, may control the transmission of the signal packaging 406. For example, the broadcast management server 412 may determine which broadcast transmitters the signal packaging 406 transmits to. In some aspects, the signal packaging 406 may receive video signals from a plurality of production controls, including the production control 404. The broadcast management server 412 may determine which video signal to be transmitted by the signal packaging 406 and thus go into the broadcast. In some aspects, the broadcast management server 412 may determine metadata to be included in the video signal that is transmitted to the broadcast transmitters 408A and 408B. For example, the broadcast management server 412 may determine to include the metadata in the video signal transmitted to the broadcast transmitter 408A. In such a case, the signal packaging 406 may embed the metadata into the video signal to be transmitted to the broadcast transmitter 408A as discussed above. The broadcast management server 412 may also determine not to include the metadata in the video signal transmitted to the broadcast transmitter 408B. In such a case, the signal packing 406 transmits the video signal without embedded metadata to the broadcast transmitter 408B. In some aspects, the broadcast management server 412 may also manage operations of the scheduling metadata server 416 and the authorization server 414 discussed below.

In some aspects, the client device 410, which can also be referred to as an ATSC 3.0 client device, may receive the video signal from the broadcast transmitter 408A. The client device 410 may be similar to the user device 102 in FIG. 1. The client device 410 may also include a betting application that provides betting programs for users of the client device 410 to make bets. In addition, the betting application may also display live events, such as the live events of the live event content 402. In some aspects, the client device 410 requires scheduling information to receive the video signal from the broadcast transmitter 408A. For example, the client device 410 needs to know when the live event is being broadcast and when the live event ends. In addition, the client device 410 needs to know the tuner ID, such as an ATSC 3.0 tuner ID, or the frequency, such as an ATSC 3.0 frequency, so that the client device 410 can configure its receiver, such as the transceiver 320 in FIG. 3, to receive the video signal from the broadcast transmitter 408A. Thus, the scheduling information may include an expected start time, an expected stop time, and channel information of the live events, wherein the channel information includes the tuner ID or the frequency. In some aspects, the client device 410 queries the scheduling information from the scheduling metadata server 416. The scheduling metadata server 416 may also be referred to as a scheduling metadata service and may be similar to the scheduling server 108 in FIG. 1.

In some aspects, the client device 410 may transmit a program information request to the scheduling metadata server 416. The program information request may indicate a geolocation of the client device 410. For example, the geolocation may be a GPS coordinate, an address, or other information that corresponds to the current location of the client device 410. The client device 410 may determine the geolocation based on a location chipset, such as a GPS chip and a GNSS chip. Furthermore, the client device may use a Broadcast Position System (BPS) in addition to or instead of the location chipset when the GPS signals are weak or unavailable. For example, the client device 410 may receive signals from one or more broadcast transmitters, such as the broadcast transmitters 408A and 408B. The signals may include time and location information so that the client device 410 may determine distances to the one or more broadcast transmitters. The client device 410 may then determine its own location based on triangulation or other methods. In addition, the user of the client device 410 may determine the geolocation and enter it into the client device 410. In some aspects, after receiving the program information request, the scheduling metadata server 416 may determine a list of live events that are available to the client device 410. Similarly as discussed in FIG. 1 above, the scheduling metadata server 416 may determine the list of live events based on locations of the broadcast transmitters, such as the broadcast transmitter 408A, and live events that are currently being broadcasted or will be broadcasted in the future by these broadcast transmitters. The scheduling metadata server 416 then transmits the scheduling information back to the client device 410.

In some aspects, the client device 410 may select one or more live events to display in the betting application. For example, the scheduling information may correspond to a plurality of live events. In such a case, the client device 410 may rank the plurality of live events based on various factors, such as popularity, distances to the client device 410, history of similar events that the user watched in the past or within a predetermined time window, or user instructions. The client device 410 may then select the one or more live events that are ranked higher than other live events in the plurality of live events. In some aspects, for each of the selected one or more live events, the client device 410 may determine the expected start time of the live event based on the scheduling information and start to monitor the video signals from the broadcast transmitter 408A based on the channel information. For example, the client device 410 may configure its receiver to receive video signals in the ATSC 3.0 frequency corresponding to the live event, as indicated in the channel information. The client device 410 can continuously monitor the video signals received from the broadcast transmitter 408A to determine: (1) whether the video signals are strong enough to decode and display the live event; and (2) whether the video signals contain the actual live event. Regarding (1), the client device 410 can analyze the signal quality of the video signals and determine whether the video signals are strong enough. For example, the signal quality may include, but not limited to, signal-to-noise ratio (SNR), received signal strength indicator (RSSI), signal-to-interference-plus-noise ratio (SINR), and other factors. The client device 410 may determine that the signal quality is higher than a predetermined threshold and thus the video signals are strong enough. Otherwise, the client device 410 may wait and keep monitoring the video signals until they are strong enough. In some aspects, the client device 410 monitors the video signals on a rolling basis. For example, the client device 410 may monitor the video signals in a sliding window. The size of the slide window may be a predetermined period, such as 2 seconds. If an average signal quality of the video in the past 2 seconds, i.e., within the sliding window, is higher than the predetermined threshold, the client device 410 determines that the video signals are strong enough. Regarding (2), the client device may determine whether the video signals actually contain the live event based on the actual start time or the start indicator embedded in the video signals as discussed above. For example, the actual start time may indicate that the live event actually starts at 7:00 PM. In some aspects, the actual start time may be different from the expected start time discussed above because the live event may be postponed or delayed. Thus, the actual start time that comes with the video signals gives a more actual time point when the live event starts. For another example, the start indicator may indicate whether the video signals that are being transmitted together with the start indicator contain the live event. Specifically, the start indicator may be a binary indicator and when the start indicator contains “1”, the client device 410 may determine that the video signals contain the live event. In either case, once the client device 410 determines that the video signals are strong enough and contain the live event, the client device 410 may start playing the live event in the betting application. In some aspects, the client device 410 may stop playing the live event once the live event ends. For example, the client device 410 may determine that the live event has ended based on the actual stop time or the stop indicator. Specifically, the actual stop time may indicate that the live event has ended at 10:00 PM, which was 10 minutes ago, or the stop indicator may indicate that the video signals no longer contain the live event. In either case, the client device 410 may stop playing the live event.

In some aspects, the client device 410 may also need to calculate a real-time delay of the video signals. For example, the production control 404 may provide timestamps of the video signals. The timestamps may be inserted into the video signals and indicate times of capture for certain frames. Specifically, the time stamps can indicate that a frame is captured at 7:31 PM. The production control 404 can insert the time stamps into the video signals transmitted to the signal packaging 406. In some aspects, the time stamps are included in the metadata together with the other information, such as the actual start time/start indicator and the actual stop time/stop indicator. Once the client device 410 receives the timestamps, the client device 410 compares the timestamps with a current time to determine a real-time delay. For example, the current time may be 7:35 PM and the timestamp indicates 7:31 PM. In such a case, the real-time delay is the difference between the two time points, which is 4 minutes. The real-time delay may be due to processing time need for devices including the production control 404, the signal packaging 406, and the broadcast transmitter 408A. In addition, it also takes time for the video signals to arrive at the client device 410. In either case, the betting application of the client device 410 may adjust the betting programs based on the real-time delay. For example, if a betting program asks the user to bet on whether a team will score in the second half of a game, the rule may be that the betting program closes 10 minutes prior to the second half starts. The game played on the betting application may show that the second half starts in 12 minutes. Thus, it appears that the betting application should close the betting program in 2 minutes. However, due to the 4-minutes real-time delay, it is only 8 minutes until the second half begins. Thus, the betting program should have been closed 2 minutes ago. Thus, by considering the real-time delay, the betting application can determine a correct time to close or open betting programs.

In some aspects, the client device 410 may need authorization to play the live event. For example, the channel information provided by the scheduling metadata server 416 may be encrypted and authorized devices are provided with decryption keys to decode the channel information. In addition, the metadata embedded in the video signals may also be encryption with the same or different decryption keys. The client device 410 may request for authorization from the authorization server 414, which is similar to the authorization server 106 in FIG. 1 and can also be referred to as authorization service. In some aspects, the client device 410 may transmit a request to the authorization server 414. The request may indicate the metadata embedded in the video signals. For example, the request may indicate an event ID of the live event. In response, the authorization server 414 may generate and transmit an approval message to the client device 410. In some aspects, the approval message may include one or more decryption keys used to decrypt the metadata corresponding to the live event received from the broadcast transmitter 408A. Similarly, the request may also indicate a demand for the channel information. In such a case, the approval message may include one or more decryption keys used to decrypt the channel information received from the scheduling metadata server 416. In some aspects, the client device may transmit a separate request for the channel information. In such a case, the authorization server may transmit a separate approval message regarding the one or more decryption keys used to decrypt the channel information.

In some aspects, a betting partner, such as an owner of the betting application, may establish and operate the betting partner application servers 420. The betting partner application servers 420 may operate similarly to the scheduling metadata server 416 and the authorization server 414. For example, the betting partner application servers 420 may receive the scheduling information from the scheduling metadata server 416 and transmit it to the client device 410. Thus, the client device 410 receives the scheduling information indirectly from the scheduling metadata server 416 via the betting partner application servers 420. In such a case, the betting partner application servers 420 can control what is provided to the client device 410. For example, instead of providing all the live events available in the area of the client device 410, the betting partner application servers 420 may filter out one or more live events that are not suitable for the betting application. In addition, the betting partner application servers 420 provide decryption keys to the client device to decrypt the metadata and the channel information. Similarly, the client device 410 receives the decryption keys indirectly from the scheduling metadata server 416 via the betting partner application servers 420. In this way, the betting partner application servers 420 may control whether the client device 410 has access to certain information.

In some aspects, the analytics collection service 418 collects performance information from the client device 410. For example, the user of the client device 410 may take a survey regarding the experience of using the betting application. The client device 410 may transmit results of the survey to the analytics collection service 418. For another example, the client device 410 may monitor the video signals received and determine an overall signal quality in a period of time. The period of time may be an entire period of the live events, half time of the live events, or other predetermined time periods. The client device 410 may transmit the overall signal quality to the analytics collection service 418. In either case, the analytics collection service 418 may use information collected from the client device 410, such as the survey result and the overall signal quality, to make adjustment in future broadcasting so that the overall performance of the broadcasting system is improved.

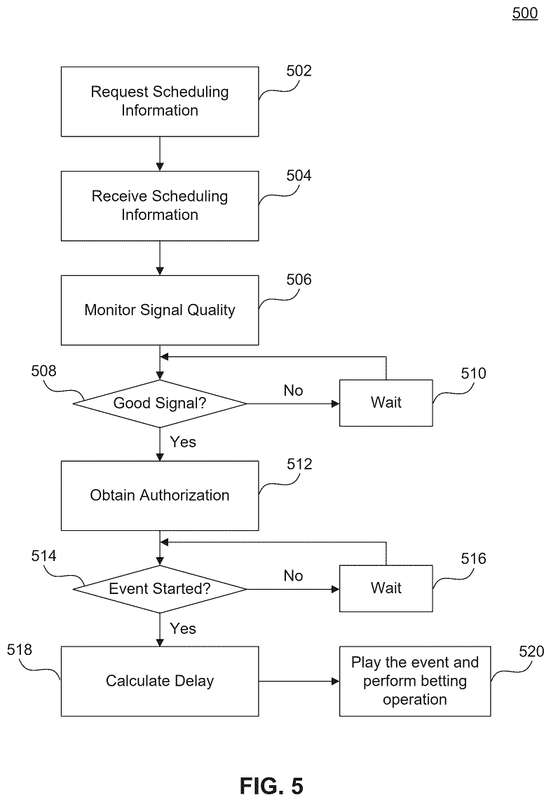

FIG. 5 illustrates an example method 500 of broadcast service, according to some aspects of the disclosure. The method 500 can be performed by processing logic that can include hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 5, as will be understood by a person of ordinary skill in the art.

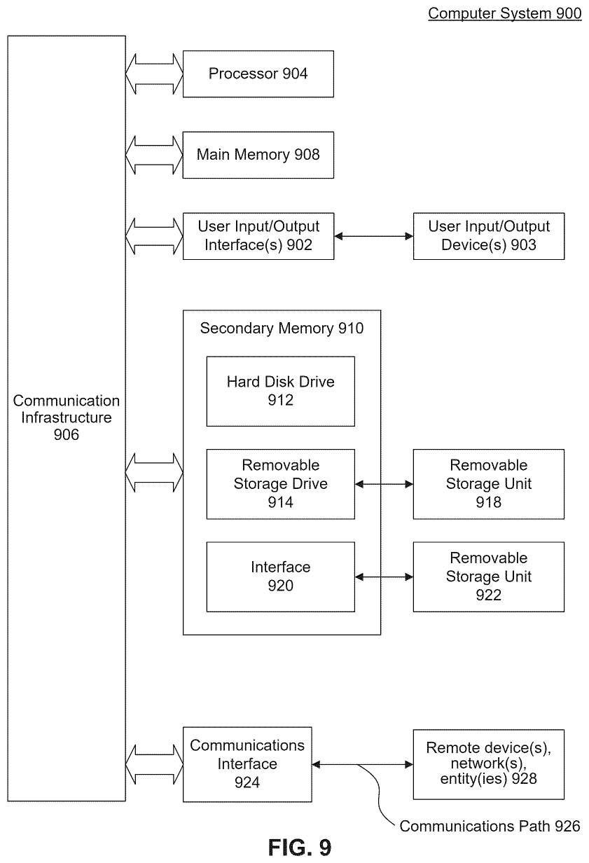

As a convenience and not a limitation, FIG. 5 may be described with regard to elements of FIGS. 1-4 and 9. The example method 500 may represent the operation of devices (e.g., the user device 102 of FIG. 1 and the client device 410 of FIG. 4) implementing the live sporting events broadcasting system for a betting application. The example method 500 may also be performed by computer system 900 of FIG. 9. But the example method 500 is not limited to the specific aspects depicted in those figures and other systems may be used to perform the method, as will be understood by those skilled in the art. It is to be appreciated that not all operations may be needed, and the operations may not be performed in the same order as shown in FIG. 5.

At 502, user device, such as the user device 102 or the client device 410, may request scheduling information from a scheduling server, such as the scheduling server 108 or the scheduling metadata server 416. For example, the user device may transmit a request to the scheduling server. In some aspects, the request may indicate a geolocation of the user device as discussed above.

At 504, the user device may receive the scheduling information from the scheduling server. In some aspects, the scheduling information may include expected start times, expected stop times, and channel information of one or more live events that are available in the geolocation of the user device. As discussed above, the scheduling server may determine a list of live events that the user device is able to receive in the geolocation and transmit the scheduling information of the list of the live events to the user device.

At 506, the user device may monitor signal quality of video signals. In some aspects, the user device may select one or more live events from the list of live events. For example, the user device may determine that the one or more live events are suitable for betting programs provided by a betting application installed on the user device. The user device then extracts the channel information of the one or more live events and monitors the signal quality of each frequency of the one or more live events. In some aspects, the channel information may be encrypted. In such a case, the user device may request access to the channel information from an authorization server, such as the authorization servers 106 and 414. As discussed above, the user device may receive a first approval message indicating one or more decryption keys used to decrypt the channel information. In some aspects, the user device may start monitoring the signal quality at the expected start time of a live event.

At 508, the user device may determine whether the signal quality of a live event is good. For example, the signal quality can be an SNR value, an RSSI value, or an SINR value. If the signal quality is lower than a predetermined threshold, the user device may determine that the signal quality of the video signals is not good enough and the control moves to 510. The user device waits a predetermined period of time and checks again whether the signal quality is good enough. If the signal quality is higher than the predetermined threshold, the user device may determine that the signal quality of the video signals is good enough and the control moves to 512.

At 512, the user device may obtain authorization to access metadata embedded in the video signals. In some aspects, the user device may transmit a request for accessing the metadata to the authorization server. As similarly discussed above, the authorization server may transmit a second approval message to the user device indicating decryption keys used to decrypt the metadata. In some aspects, the user device may request for accessing the channel information, as discussed in 506, and accessing for the metadata in one request. In such a case, the authorization device may combine the first and the second approval messages into a bundle approval message and transmit the bundle approval message to the user device. Therefore, the user device may have received the decryption keys used to decrypt the metadata at the step 506 and the step 512 can be skipped.

At 514, the user device determines whether the live event has started. In some aspects, the live event may be postponed or delayed for various reasons, such as weather, equipment preparation, or other onsite situations. Thus, the user device wants to know when the live event actually kicks off. As discussed above, the metadata embedded in the video signal may include an actual start time or a start indicator. Since the user device obtained the authorization and decryption keys of the metadata, the user device may decode the metadata and determine whether the live event has started based on the metadata. If the user device determines that the live event has not started yet, the control moves to 516 and the user device waits for an event pending period to check again. If the user device determines that the live event has started, the control moves to 518.

At 518, the user device calculates a real-time delay in the video signal. As discussed above, the video signals may include metadata that includes a timestamp indicating a time of capture of the video signals. The user device may retrieve the timestamp when decoding the metadata. Furthermore, the user device may determine a current time based on a time service. Finally, the user device can determine the real-time delay based on the time of capture and the current time. For example, the user device may determine the real-time delay by subtracting the time of capture from the current time.

At 520, the user device may play the live event and perform betting operations. In some aspects, the user device determines that the signal quality is good at 508 and that the live event has started at 514. In such a case, the user device may decode the video signals and display the live event in the betting application. In addition, the betting application may perform the betting operations by offering one or more betting programs in the betting application while displaying the live event. In some aspects, the one or more betting programs are in association with the live event. For example, the live event may be a soccer game and the one or more betting programs may ask the user to bet whether and/or which team will score in the live event. As discussed above, the one or more betting programs may have time requirements. In such a case, the betting application considers the real-time delay when opening or closing the betting programs. For example, if a betting program is supposed to close 10 minutes after the live event starts and the real-time delay is 3 minutes, the betting application closes the betting program when displaying 7 minutes into the game so that the real-time delay is factored in.

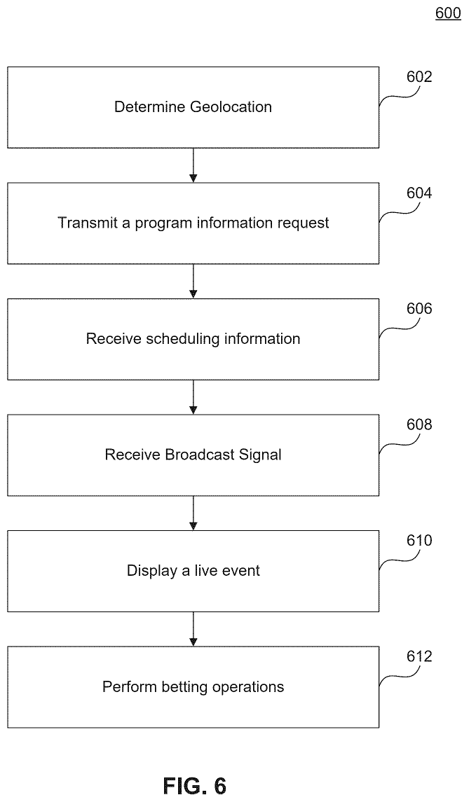

FIG. 6 illustrates an example method 600 of playing a live event, according to some aspects of the disclosure. The method 600 can be performed by processing logic that can include hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 6, as will be understood by a person of ordinary skill in the art.

As a convenience and not a limitation, FIG. 6 may be described with regard to elements of FIGS. 1-4 and 9. The example method 600 may represent the operation of devices (e.g., the user device 102 of FIG. 1 and the client device 410 of FIG. 4) implementing the live sporting events broadcasting system for a betting application. For example, the example method 600 may represent the operation of a betting application of the devices, such as the betting application of the user device 102 or the betting application of the client device 410. The example method 600 may also be performed by computer system 900 of FIG. 9. But the example method 600 is not limited to the specific aspects depicted in those figures and other systems may be used to perform the method, as will be understood by those skilled in the art. It is to be appreciated that not all operations may be needed, and the operations may not be performed in the same order as shown in FIG. 6.

At 602, a betting application of a user device, such as the user device 102 or the client device 410, may determine a geolocation of the user device. In some aspects, the user device may include a chipset for location services, such as a GPS chip or a GNSS chip. In such a case, the betting application may configure the user device to communicate with a satellite to determine its geolocation. The geolocation may be a coordinate that includes a longitude and a latitude. The geolocation can also be a street address, a building name, a city name, or other things that are related to the geolocation of the user device.

At 604, the betting application of the user device may transmit a program information request to a scheduling server, such as the scheduling server 108 or the scheduling metadata server 416. For example, the betting application may configure a transceiver of the user device, such as the transceiver 320, to transmit the program information request. In some aspects, the request may indicate the geolocation of the user device as discussed above.

At 606, the betting application of the user device may receive scheduling information of a live event in the geolocation from the scheduling server. For example, the betting application may configure the transceiver of the user device to receive the scheduling information. In some aspects, the scheduling server may identify a list of events that are available in the geolocation of the user device. The scheduling server may transmit scheduling information of one or more live events on the list and the one or more live events include the live event. In some aspects, the scheduling information may include an expected start time, an expected stop time, and channel information of the live event. The channel information may include an ATSC 3.0 frequency or an ATSC 3.0 tuner ID. In some aspects, the channel information may be encrypted. In such a case, the user device may request for access the channel information from an authorization server, such as the authorization servers 106 and 414, as discussed above.

At 608, the betting application of the user device may receive a broadcast signal based on the scheduling information. For example, the betting application may configure the transceiver of the user device to receive the broadcast signal. In some aspects, a broadcast transmitter, such as the broadcast device 104 or the broadcast transmitter 408A, may transmit the broadcast signal on the ATSC 3.0 frequency that includes video signals of the live event. The user device may tune its receiver, such as the transceiver 320, to the ATSC 3.0 frequency to receive the broadcast signal.

In some aspects, the broadcast signal may include metadata. The metadata may include an actual start time/start indicator or an actual end time/end indicator. In such a case, the user device may determine that the live event has started based on the actual start time or the start indicator and thus start displaying the live event. On the other hand, the user device may determine that the live event has ended based on the actual end time or the end indicator and thus stop displaying the live event. In some aspects, the metadata may further include a timestamp indicating a time of capture. The user device may determine a real-time delay based on the timestamp and a current time. In this way, the user device may perform one or more betting operations, such as betting programs, based on the delay.

In some aspects, the metadata are encrypted. In such a case, the user device may transmit a request for accessing the metadata to the authorization server. The authorization server may transmit an approval message to the user device, which includes one or more decryption keys used to decrypt the metadata.

At 610, the betting application of the user device may display the live event based on the broadcast signal.

At 612, the betting application of the user device may perform one or more betting operations in association with the live event. In some aspects, the one or more betting operations may offer one or more betting programs. The live event may be a soccer game. In such a case, the one or more betting programs may ask the user of the betting application which team will win the soccer game.

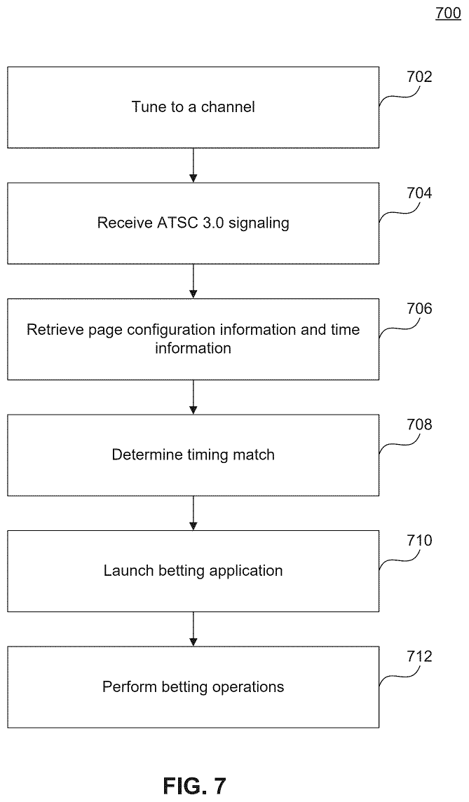

FIG. 7 illustrates an example method 700 of launching a betting application, according to some aspects of the disclosure. The method 700 can be performed by processing logic that can include hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 7, as will be understood by a person of ordinary skill in the art.

As a convenience and not a limitation, FIG. 7 may be described with regard to elements of FIGS. 1-4 and 9. The example method 700 may represent the operation of devices (e.g., the packager 202, the broadcaster 204, and the receiver 206 of FIG. 2) implementing the live sporting events broadcasting system for a betting application. The example method 700 may also be performed by computer system 900 of FIG. 9. But the example method 700 is not limited to the specific aspects depicted in those figures and other systems may be used to perform the method, as will be understood by those skilled in the art. It is to be appreciated that not all operations may be needed, and the operations may not be performed in the same order as shown in FIG. 7.

At 702, a user device, such as the receiver 206, tunes to a channel corresponding to a live event. As discussed above, the receiver may receive scheduling information of the live event in a geolocation from a scheduling server and the scheduling information may include or indicate the channel.

At 704, the user device may receive ATSC signaling (or signaling configured according to other ATSC standards), such as ATSC 3.0 signaling, via the channel.

At 706, the user device may retrieve paging configuration information and time information from the ATSC 3.0 signaling. In some aspects, the page configuration information includes HELD and the time information includes DWD. The HELD may include or indicate URLs that lead to interactive HTML5 pages containing a betting application, such as the betting application 216. The DWD may include or indicate a timing window of a live event being broadcasted in the ATSC 3.0 signaling.

At 708, the user device may determine that a current time matches the time information. In some aspects, the user device may determine the current time based on a time service or an internal clock of the user device. The user device then determines whether the current time is within the timing window indicated by the DWD. If the current time is within the timing window, the user device determines that the current time matches the time information. Otherwise, the user device determines that the current time does not match the time information.

At 710, the user device launches the betting application. In some aspects, the betting application can be launched within the user device or at another device. In either case, the user device retrieves the URLs from the HELD and launches the betting application using the URLs. For example, the user device can launch the betting application in a browser of the user device using the URLs. For another example, the user device can transmit the URLs to the other device, which can launch the betting application using the URLs.

At 712, the user device may perform the one or more betting operations using the betting application in association with the live event. In some aspects, the one or more betting operations may offer one or more betting programs that users can make bets with. The live event may be a soccer game. In such a case, the one or more betting programs may ask the users of the betting application which team will win the soccer game.

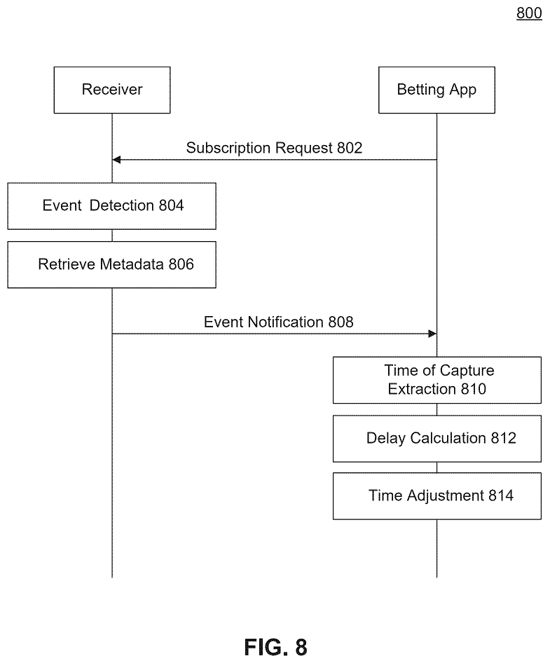

FIG. 8 illustrates an example method 800 of calculating and using delay, according to some aspects of the disclosure. The method 800 can be performed by processing logic that can include hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 8, as will be understood by a person of ordinary skill in the art.

As a convenience and not a limitation, FIG. 8 may be described with regard to elements of FIGS. 1-4 and 9. The example method 800 may represent the operation of devices (e.g., the packager 202, the broadcaster 204, and the receiver 206 of FIG. 2) implementing the live sporting events broadcasting system for a betting application. The example method 800 may also be performed by the computer system 900 of FIG. 9. But the example method 800 is not limited to the specific aspects depicted in those figures and other systems may be used to perform the method, as will be understood by those skilled in the art. It is to be appreciated that not all operations may be needed, and the operations may not be performed in the same order as shown in FIG. 8.

At 802, a betting application, such as the betting application 216, transmits a subscription request to a receiver, such as the receiver 206. The subscription request may include a schemeIdUri and optionally a value. In some aspects, the schemeIdUri identifies an event type of a live event, such as “urn:bet:timeofcapture:2025” or a UUID. The value can include conditions that filter events, such as “goal,” “halftime,” or “kickoff.”

At 804, the receiver performs event detection. For example, the receiver can monitor received signals, such as the ATSC 3.0 signaling. The receiver may determine that a broadcast stream included in the ATSC 3.0 signaling matches the subscription request, wherein the broadcast stream may include MMT signals and/or DASH/ROUTE signals. For example, the live event included in the broadcast stream of the ATSC 3.0 signaling may match the schemeIdUri or the UUID. Specifically, the live event may be the type of event indicated by the schemeIdUri. Alternatively, the live event may include an ID that matches the UUID. Furthermore and optionally, the receiver may monitor SCTE-35 markers included in the broadcast stream of the ATSC 3.0 signaling. As discussed above, the SCTE-35 markers may include metadata that includes or indicates time of capture information. In some aspects, the time of capture information includes time points when the broadcast stream in the ATSC 3.0 was captured. For example, the time of capture information may include or indicate a time point of an event, such as a starting time of a soccer game, a time point of a goal, a mid time, or others. Thus, the receiver may determine the event corresponds to the SCTE-35 marker and matches the value. For example, the SCTE-35 marker may include the time of capture information of a goal event. Thus, the time of capture information includes a time of a goal. If the value also indicates “goal,” the receiver may determine that the SCTE-35 marker matches the value. In either case, when the receiver determines that the broadcast stream matches the subscription request, the control moves to 806.

At 806, the receiver retrieves the metadata. For example, the receiver can retrieve the SCTE-35 marker from the ATSC 3.0 signaling. The receiver can then determine the time of capture information based on the SCTE-35 marker.

At 808, the receiver can transmit an event notification to the betting application. The event notification can include the time of capture information. In some aspects, the event notification can further include an event time, a receiving time, an event ID, and content encoding information. The event time may indicate a time point when the event occurred. For example, the event may be a goal and the event time indicates when the goal was scored. The receiving time indicates a time when the metadata, such as the SCTE-35 marker was received. The event ID indicates an ID of the event itself. For example, a goal may have an event ID that is different from the start of the game. Finally, the content encoding information indicates how the ATSC 3.0 signaling and the broadcast content included in it were encoded. The receiver can determine a method to decoding the ATSC 3.0 signaling based on the content encoding information.

At 810, the betting application can determine a time of capture based on the metadata. The receiver can further determine a current time based on a time service or an internal clock.

At 812, the betting application can determine a real-time delay based on a difference between the current time and the time of capture. The real-time delay may be caused by transmission, processing time, and other factors.

At 814, the betting application can perform time adjustment based on the real-time delay. For example, the betting application may determine that the real-time delay is 5 seconds. The betting application may offer a betting program that bets on which team wins at the end of the game. Because of the real-time delay, when the betting application plays the end of the game, the game may have ended 5 seconds ago. In such a case, the betting application can close the betting program at least 5 seconds prior to playing the end of the game. In some aspects, the betting application can close any other betting programs offered at least 5 seconds early for similar reasons.

Various aspects may be implemented, for example, using one or more well-known computer systems, such as computer system 900 shown in FIG. 9. One or more computer systems 900 may be used, for example, to implement any of the aspects discussed herein, as well as combinations and sub-combinations thereof.

Computer system 900 may include one or more processors (also called central processing units, or CPUs), such as a processor 904. Processor 904 may be connected to a communication infrastructure or bus 906.

Computer system 900 may also include user input/output device(s) 903, such as monitors, keyboards, pointing devices, etc., which may communicate with communication infrastructure 906 through user input/output interface(s) 902.

One or more of processors 904 may be a graphics processing unit (GPU). In an aspect, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 900 may also include a main or primary memory 908, such as random access memory (RAM). Main memory 908 may include one or more levels of cache. Main memory 908 may have stored therein control logic (i.e., computer software) and/or data.

Computer system 900 may also include one or more secondary storage devices or memory 910. Secondary memory 910 may include, for example, a hard disk drive 912 and/or a removable storage device or drive 914. Removable storage drive 914 may be a floppy disk drive, a magnetic tape drive, a compact disk drive, an optical storage device, tape backup device, and/or any other storage device/drive.

Removable storage drive 914 may interact with a removable storage unit 918. Removable storage unit 918 may include a computer usable or readable storage device having stored thereon computer software (control logic) and/or data. Removable storage unit 918 may be a floppy disk, magnetic tape, compact disk, DVD, optical storage disk, and/any other computer data storage device. Removable storage drive 914 may read from and/or write to removable storage unit 918.

Secondary memory 910 may include other means, devices, components, instrumentalities or other approaches for allowing computer programs and/or other instructions and/or data to be accessed by computer system 900. Such means, devices, components, instrumentalities or other approaches may include, for example, a removable storage unit 922 and an interface 920. Examples of the removable storage unit 922 and the interface 920 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 900 may further include a communication or network interface 924. Communication interface 924 may enable computer system 900 to communicate and interact with any combination of external devices, external networks, external entities, etc. (individually and collectively referenced by reference number 928). For example, communication interface 924 may allow computer system 900 to communicate with external or remote devices 928 over communications path 926, which may be wired and/or wireless (or a combination thereof), and which may include any combination of LANs, WANs, the Internet, etc. Control logic and/or data may be transmitted to and from computer system 900 via communication path 926.

Computer system 900 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 900 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 900 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some aspects, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 900, main memory 908, secondary memory 910, and removable storage units 918 and 922, as well as tangible articles of manufacture embodying any combination of the foregoing. Such control logic, when executed by one or more data processing devices (such as computer system 900), may cause such data processing devices to operate as described herein.

Based on the teachings contained in this disclosure, it will be apparent to persons skilled in the relevant art(s) how to make and use aspects of this disclosure using data processing devices, computer systems and/or computer architectures other than that shown in FIG. 9. In particular, aspects can operate with software, hardware, and/or operating system implementations other than those described herein.

It is to be appreciated that the Detailed Description section, and not any other section, is intended to be used to interpret the claims. Other sections can set forth one or more but not all exemplary aspects as contemplated by the inventor(s), and thus, are not intended to limit this disclosure or the appended claims in any way.

While this disclosure describes exemplary aspects for exemplary fields and applications, it should be understood that the disclosure is not limited thereto. Other aspects and modifications thereto are possible, and are within the scope and spirit of this disclosure. For example, and without limiting the generality of this paragraph, aspects are not limited to the software, hardware, firmware, and/or entities illustrated in the figures and/or described herein. Further, aspects (whether or not explicitly described herein) have significant utility to fields and applications beyond the examples described herein.

Aspects have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative aspects can perform functional blocks, steps, operations, methods, etc. using orderings different than those described herein.

References herein to “one aspect,” “an aspect,” “an example aspect,” or similar phrases, indicate that the aspect described can include a particular feature, structure, or characteristic, but every embodiment can not necessarily include the particular feature, structure, or characteristic. Moreover, such phrases are not necessarily referring to the same aspect. Further, when a particular feature, structure, or characteristic is described in connection with an aspect, it would be within the knowledge of persons skilled in the relevant art(s) to incorporate such feature, structure, or characteristic into other aspects whether or not explicitly mentioned or described herein. Additionally, some aspects can be described using the expression “coupled” and “connected” along with their derivatives. These terms are not necessarily intended as synonyms for each other. For example, some aspects can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary aspects, but should be defined only in accordance with the following claims and their equivalents.

Some non-limiting Examples of various aspects are provided below.

Example 1 may include a user device comprising a memory and at least one processor coupled to the memory. That at least one processor is configured to tune to a channel corresponding to a live event and receive advanced television systems committee (ATSC) signaling via the channel. That at least one processor is further configured to retrieve page configuration information and time information from the ATSC signaling and determine that a current time matches the time information. Finally, that at least one processor is further configured to launch a betting application using the page confirmation information and perform one or more betting operations using the betting application in association with the live event.

Example 2 may include a method of computer-implemented method for a user device. The method includes tuning to a channel corresponding to a live event and receiving advanced television systems committee (ATSC) signaling via the channel. The method further includes retrieving page configuration information and time information from the ATSC signaling and determining that a current time matches the time information. Finally, the method further includes launching a betting application using the page confirmation information and performing one or more betting operations using the betting application in association with the live event.

Example 3 may include a non-transitory computer-readable medium (CRM) comprising instructions to, upon execution of the instructions by one or more processors of a user device, cause the user device to perform operations. The operations include tuning to a channel corresponding to a live event and receiving advanced television systems committee (ATSC) signaling via the channel. The operations further include retrieving page configuration information and time information from the ATSC signaling and determining that a current time matches the time information. Finally, the operations further include launching a betting application using the page confirmation information and performing one or more betting operations using the betting application in association with the live event.

What is claimed is:

1. A user device, comprising:
a memory; and
at least one processor coupled to the memory and configured to:
tune to a channel corresponding to a live event;
receive advanced television systems committee (ATSC) signaling via the channel;
retrieve page configuration information from the ATSC signaling;
retrieve time information from the ATSC signaling;
determine that a current time matches the time information;
launch a betting application using the page confirmation information; and
perform one or more betting operations using the betting application in association with the live event.

2. The user device of claim 1, wherein the page configuration information includes hypertext markup language (HTML) entry pages location description (HELD).

3. The user device of claim 1, wherein the time information includes distribution window description (DWD).

4. The user device of claim 1, wherein the at least one processor is further configured to:
retrieve time of capture information from the ATSC signaling;
determine the current time;
determine a delay; and
perform the one or more betting operations based on the delay.

5. The user device of claim 4, wherein to retrieve the time of capture information from the ATSC signaling, the at least one processor is further configured to:
retrieve broadcast stream from the ATSC signaling; and
retrieve metadata from the broadcast stream, wherein the metadata includes the time of capture information.

6. The user device of claim 5, wherein the broadcast stream includes moving picture experts group (MPEG) media transport (MMT) signals or dynamic adaptive streaming over hypertext markup language (HTML)/real-time object delivery over unidirectional transport (DASH/ROUTE) signals.

7. The user device of claim 5, wherein the metadata includes society of cable telecommunications engineers (SCTE)-35 marker.

8. The user device of claim 5, wherein to retrieve the metadata, the at least one processor is further configured to:
receive a subscription request from the betting application;
determine that the broadcast stream matches the subscription request;
retrieve the metadata from the broadcast stream; and
transmit an event notification to the betting application, wherein the event notification includes the metadata.

9. The user device of claim 8, wherein the event notification further includes an event time, a receiving time, an event identification (ID), and a content encoding information.

10. A computer-implemented method for a user device, comprising:
tuning to a channel corresponding to a live event;
receiving advanced television systems committee (ATSC) signaling via the channel;
retrieving page configuration information from the ATSC signaling;
retrieving time information from the ATSC signaling;
determining that a current time matches the time information;
launching a betting application using the page confirmation information; and
performing one or more betting operations using the betting application in association with the live event.

11. The computer-implemented method of claim 10,
wherein the page configuration information includes hypertext markup language (HTML) entry pages location description (HELD), and
wherein the time information includes distribution window description (DWD).

12. The computer-implemented method of claim 10, further comprising:
retrieving time of capture information from the ATSC signaling;
determining the current time;
determining a delay; and
performing the one or more betting operations based on the delay.

13. The computer-implemented method of claim 12, wherein retrieving the time of capture information from the ATSC signaling further comprises:
retrieving broadcast stream from the ATSC signaling; and
retrieving metadata from the broadcast stream, wherein the metadata includes the time of capture information.

14. The computer-implemented method of claim 13, wherein retrieving the metadata further comprising:
receiving a subscription request from the betting application;
determining that the broadcast stream matches the subscription request;
retrieving the metadata from the broadcast stream; and
transmitting an event notification to the betting application, wherein the event notification includes the metadata.

15. The computer-implemented method of claim 14, wherein the event notification further includes an event time, a receiving time, an event identification (ID), and a content encoding information.

16. A non-transitory computer-readable medium (CRM) comprising instructions to, upon execution of the instructions by one or more processors of a user device, cause the user device to perform operations, the operations comprising:
tuning to a channel corresponding to a live event;
receiving advanced television systems committee (ATSC) signaling via the channel;
retrieving page configuration information from the ATSC signaling;
retrieving time information from the ATSC signaling;
determining that a current time matches the time information;
launching a betting application using the page confirmation information; and
performing one or more betting operations using the betting application in association with the live event.

17. The non-transitory CRM of claim 16,
wherein the page configuration information includes hypertext markup language (HTML) entry pages location description (HELD), and
wherein the time information includes distribution window description (DWD).

18. The non-transitory CRM of claim 16, wherein the operations further comprise:
retrieving time of capture information from the ATSC signaling;
determining the current time;
determining a delay; and
performing the one or more betting operations based on the delay.

19. The non-transitory CRM of claim 18, wherein retrieving the time of capture information from the ATSC signaling further comprises:
retrieving broadcast stream from the ATSC signaling; and
retrieving metadata from the broadcast stream, wherein the metadata includes the time of capture information.

20. The non-transitory CRM of claim 19, wherein retrieving the metadata further comprising:
receiving a subscription request from the betting application;
determining that the broadcast stream matches the subscription request;
retrieving the metadata from the broadcast stream; and
transmitting an event notification to the betting application, wherein the event notification includes the metadata.
